(19) United States
(12) Patent Application Publication
(10) Pub. No.: US 2022/0098001 A1
(43) Pub. Date: Mar. 31, 2022

(54) VESSEL-SUPPORTABLE FLEXIBLE-ELONGATE-ELEMENT SPOOLING SYSTEM

(71) Applicant: MAATS TECH LIMITED, Hampshire (GB)

(72) Inventors: Stephen Arthur Brown, Hampshire (GB); Gavin Michael Rippe, Hampshire (GB); Christopher Ambrose Scott Hickling, Hampshire (GB)

(73) Assignee: MAATS TECH LIMITED, Hampshire (GB)

(21) Appl. No.: 17/428,229

(22) PCT Filed: Feb. 4, 2020
(86) PCT No.: PCT/GB2020/050250

§ 371 Date: Aug. 3, 2021

(30) Foreign Application Priority Data
Feb. 4, 2019 (GB) 1901529.6

(51) Int. Cl. B65H 54/80; F16L 1/20

(52) U.S. Cl. CPC B65H 54/80; H02G 1/10; F16L 1/207; F16L 1/203

(57) ABSTRACT

A vessel-supportable flexible-elongate-element spooling system (100) for spooling a flexible elongate element (12). The system comprises a container (14) having an internal volume defined by a radially inner barrier (22), a radially outer barrier (24), and a base (26). A flexible-elongate-element feeder (18) feeds the flexible elongate element (12) towards the base (26) of the container (14). A flexible-elongate-element force applicator (20) applies a force to the flexible elongate element (12) to retain a curvature imparted to the flexible elongate element (12) on discharge from the flexible-elongate-element feeder (18). The curvature is at least in part defined by the inner barrier (22) and/or the outer barrier (24).

The present invention relates to a flexible-elongate-element spooling system, and in particular to a vessel-supportable flexible-elongate-element spooling system. The invention further relates to a method of spooling a flexible elongate element into a container of a vessel and a vessel-supportable flexible-elongate-element spooling apparatus.

Flexible elongate elements, such as power transmission cables; telecommunication cables; oil and gas flexible pipes; steel catenary risers; chains; thermoplastic composite pipes, which typically are carbon fibres in a thermoplastic matrix; or umbilicals, which for example may include a sheath with a plurality of flexible elements therein including control cables, hydraulic pipes and electrical supply cables, are required to be transported via vessels on water, typically being transported to an overboarding location at sea where the flexible elongate element is overboarded into the sea from the same vessel.

Such flexible elongate elements are conventionally stored in carousels, which are cylindrical storage containers, the flexible elongate element being spooled or coiled around the inside of the storage container.

The flexible elongate elements typically have a degree of rigidity, and therefore the flexible elongate elements may resist against being coiled or spooled, particularly if the desired curvature of the flexible elongate element in the carousel is great. Such resistance tends to cause the flexible elongate element to straighten, which causes poor packing, stacking or tessellation of the flexible elongate element with itself and therefore results in gapping or space between radially adjacent layers or coils of flexible elongate element.

Gapping can allow movement of the flexible elongate element during transit, which can result in damage to or crushing of the flexible elongate element. Additionally, gapping can reduce the amount of flexible elongate element able to be stored in the carousel, which in tum reduces the continuous length of flexible elongate element able to be laid. Since separate flexible elongate elements, and in particular power transmission or communication cables, are typically complicated and very time consuming to connect to each other, insufficient length of flexible elongate element can be problematic.

Currently, gapping is reduced by the use of workers in the container who manually manipulate the position of the flexible elongate element with the use of paddles. However, such manual manipulation is tedious and laborious, due to the length of the flexible elongate elements, which can be of the order of hundreds of kilometres. Additionally, the workers are required to walk on underlying flexible elongate element coils, and this represents a trip hazard. There are therefore health and safety issues related to this arrangement.

Furthermore, workers may be unable to manipulate the flexible elongate element into sufficiently tight curvatures, and therefore, particularly when coiling flexible elongate element from an outer wall to an inner wall of the container, gapping can still occur, especially at or adjacent to a central portion of the container.

The present invention seeks to provide a solution to these problems.

According to a first aspect of the invention there is provided a vessel-supportable flexible-elongate-element spooling system for spooling a flexible elongate element, the system comprising: a container having an internal volume defined by a radially inner barrier, a radially outer barrier, and a base; a flexible-elongate-element feeder for feeding the flexible elongate element towards the base of the container; and a flexible-elongate-element force applicator for applying a force to the flexible elongate element to retain a curvature imparted to the flexible elongate element on discharge from the flexible-elongate-element feeder, the curvature at least in part defined by the inner barrier and/or the outer bather.

The application of a force prevents the flexible elongate element from straightening and maintains a desired curvature which is at least in part defined by or corresponds to the curvature of the bathers. This is because the force applicator maintains a strain on the flexible elongate element. This may be achieved by clamping the flexible elongate element into position, pushing the flexible elongate element into the outer bather, or pulling the flexible elongate element around the inner barrier. By preventing the flexible elongate element from straightening, gapping is reduced.

Preferably, the spooling system may further comprise a radial support which extends across at least part of a radial extent of the container, the radial support configured to support the feeder and/or the force applicator. A radial support provides additional stiffitess, rigidity and/or strength to the spooling system. Such additional rigidity may be required due to the reactionary force on the force applicator generated by the holding the flexible elongate element under strain. Additionally, the force applicator or guide may have a relatively great weight or low stiffness which requires additional local support.

Advantageously, the force applicator may comprise a flexible-elongate-element engagement member at or adjacent to a container-base-proximal end of the feeder. An engagement member allows for the flexible elongate element to be clamped to the base of the container or an uppermost layer of flexible elongate element, or have a force applied thereto at or adjacent to the container.

Beneficially, the flexible-elongate-element engagement member may be rotatable for rotatably engaging with the flexible elongate element. Such rotation reduces frictional engagement between the engagement member and the flexible elongate element.

In a preferable embodiment the rotatable element may comprise a roller. A roller is a rotatable element with a relatively simple construction and few moving parts.

Alternatively, the rotatable element may comprise a tracked element. A tracked element can provide a better distribution of force on the flexible elongate element than a roller.

Additionally, the engagement member may include a sensor for measuring a rate of rotation of the flexible-elongate-element engagement member. A sensor allows for a tangential speed of motion of the container base at an outlet of the guide to be measured. A rate of rotation of the container and/or a rate of feeding can then be adjusted accordingly.

Optionally, the flexible-elongate-element engagement member may have a concave engagement surface which corresponds to the in-use flexible elongate element, for example a diablo roller. This provides lateral engagement or support to the flexible elongate element.

Additionally or alternatively, the flexible-elongate-element engagement member may have one concave engagement surface at each lateral edge of the engagement member. This may allow for the outward facing concave surface to pin the flexible elongate element against the outer barrier, when spooling in an inward direction. Similarly, an inward facing concave surface can pin the flexible elongate element against the inner barrier, when spooling in an outward direction.

Preferably, the feeder may include a guide configured to define or impart a curvature of the flexible elongate element. The guide restricts the bend radius of the flexible elongate element. This prevents or limits the flexible elongate element from adopting a wide catenary curve, or catenary-like curve, as it would if only supported at each end.

Advantageously, the guide may be configured to define or impart a helical curve to the flexible elongate element. A helical curve allows for the flexible elongate element to be curved to match the curvature of the container barriers whilst descending to the base.

Beneficially, the guide may have a plurality of flexible-elongate-element guide elements which are spaced apart and oriented to define a helical curve therebetween. Spaced apart guide elements, rather than a continuous tube, prevent or limit the flexible elongate element from jamming in the tube. This is due to flexible elongate elements typically having bitumen and fibres on an external surface thereof, which can cause blockages if engaged with the wall of the tube.

In a preferable embodiment, the force applicator may have a clamping condition for clamping the flexible elongate element to a base of the container or a flexible elongate element upper layer. Clamping or pinning the flexible elongate element prevents or limits the flexible elongate element from straightening, and does not require positively, actively or axially driving the flexible elongate element.

Optionally, the force applicator may further comprise an actuator configured to adjust a pressure applied by the engagement member on the in-use flexible elongate element. This allows for the force applicator to adjust for flexible elongate elements having various flexibilities, and therefore requiring differing pinning force.

Additionally, the force applicator may have a pushing condition for pushing the flexible elongate element outwards when spooling the flexible elongate element from the outer bather to the inner barrier. A pushing force prevents or limits the flexible elongate element from straightening, and thus not necessitate applying a downward pressure on the flexible elongate element, which could result in damage to flexible elongate element sheathing.

Optionally, the force applicator may have a pulling condition for pulling the flexible elongate element inwards when spooling the flexible elongate element from the inner barrier to the outer bather. A pulling force similarly prevents or limits the flexible elongate element from straightening, and thus not necessitate applying a downward pressure on the flexible elongate element.

Furthermore, the spooling system may further comprise a switching means, or a switching element, for switching the force applicator between the pushing condition and the pulling condition. This allows for the same spooling system to spool inwardly and outwardly.

Preferably, the pushing condition and/or the pulling condition is configured to act along an axial extent of the flexible elongate element.

Advantageously, the flexible-elongate-element engagement member may be driven for pushing and/or pulling the flexible elongate element. This allows for the pushing and pulling forces to be imparted at the discharge point of the flexible elongate element into the container. Therefore, the flexible elongate element is not required to be stressed when traversing the feeder.

Beneficially, at least part of the container may be rotatable. Therefore, a difference in feeding speed and rotation speed can act as the force applicator.

In a preferable embodiment, a speed of rotation of at least part of the container may be adjustable. This allows for an adjustment of force applied to the flexible elongate element and a speed of spooling.

Preferably, the feeder may be moveable along the radial support. The feeder being moveable allows for the flexible elongate element to be directed to different radial positions of the container.

Beneficially, the guide may be pivotable. In this way, the flexible elongate element may be directed to different vertical positions of the container.

Optionally, the guide may comprise a tube. The tube may restrict the flexible elongate element along a greater axial extent thereof.

Additionally, at least part of the axial extent of the tube may be openable. This allows for bitumen, or other substances which may cause blockages, to be removed from the tube.

Advantageously, the force-applicator may be a tensioner. A tensioner can allow for a force to be applied to the flexible elongate element without requiring a pinning element, such as a roller, in the container. In a preferable embodiment, the tensioner may be a wheeled tensioner.

Preferably, the container may include at least one partition between the inner barrier and the outer barrier. Partitions can assist in defining the curvature of the flexible elongate element.

According to a second aspect of the invention there is provided a method of spooling a flexible elongate element into a container of a vessel, the container having a cylindrical inner barrier and a cylindrical outer barrier, the method comprising the steps: feeding the flexible elongate element towards a base of the container; and applying a force to the flexible elongate element to hold a curvature of the flexible elongate element.

Preferably, at least part of the container may be rotatable and force may be applied to the flexible elongate element when spooling from the inner barrier to the outer barrier by adjusting a rate of rotation of said at least part of the container and a rate of feeding of the flexible elongate element so that the rate of rotation is greater than a rate of feeding.

Additionally, at least part of the container may be rotatable and force may be applied to the flexible elongate element when spooling from the outer barrier to the inner barrier by adjusting a rate of rotation of said at least part of the container and a rate of feeding of the flexible elongate element so that the rate of rotation is less than the rate of feeding.

According to a third aspect of the invention there is provided a vessel-supportable spooling apparatus for spooling a flexible elongate element into a vessel-mountable container, the apparatus comprising: a flexible-elongate-element feeder for feeding the flexible elongate element towards a base of the container; and a flexible-elongate-element force applicator for applying a force to the flexible elongate element to retain a curvature imparted to the flexible elongate element on discharge from the flexible-elongate-element feeder.

According to a fourth aspect of the invention there is provided a flexible-elongate-element spooling system for spooling a flexible elongate element, the system comprising: a container having an internal volume defined by a radially inner barrier, a radially outer barrier, and a base; a flexible-elongate-element feeder for feeding the flexible elongate element towards the base of the container; and a flexible-elongate-element force applicator for applying a force to the flexible elongate element to retain a curvature imparted to the flexible elongate element on discharge from the flexible-elongate-element feeder, the curvature at least in part defined by the inner barrier and/or the outer bather.

The invention will now be more particularly described, by way of example only, with reference to the accompanying drawings, in which:

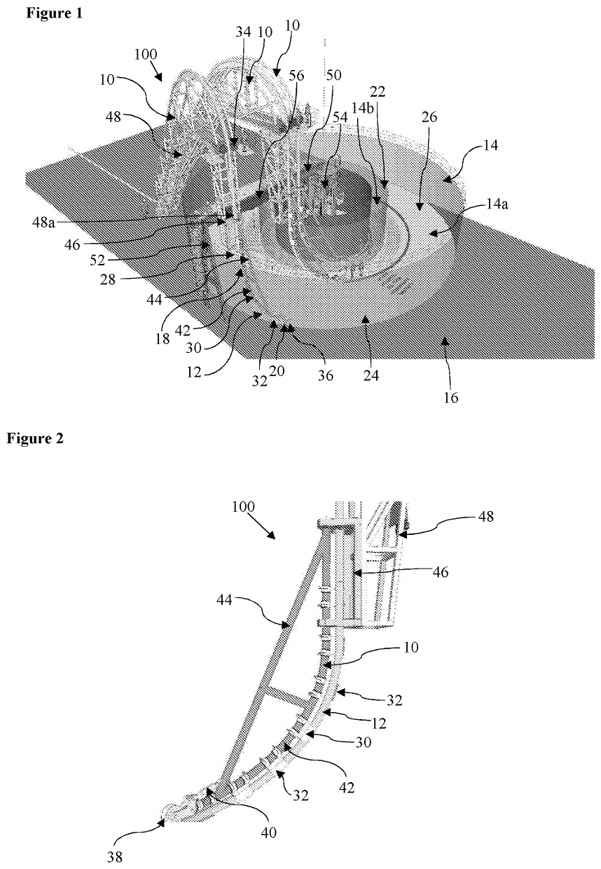

FIG. 1 shows an isometric view of a first embodiment of a vessel-supportable flexible-elongate-element spooling system according to first aspect of the present invention, the spooling system having a spooling apparatus, in accordance with a third aspect of the present invention, three positions of the spooling apparatus being shown;

FIG. 2 shows a side view of one of the spooling apparatuses of FIG. 1;

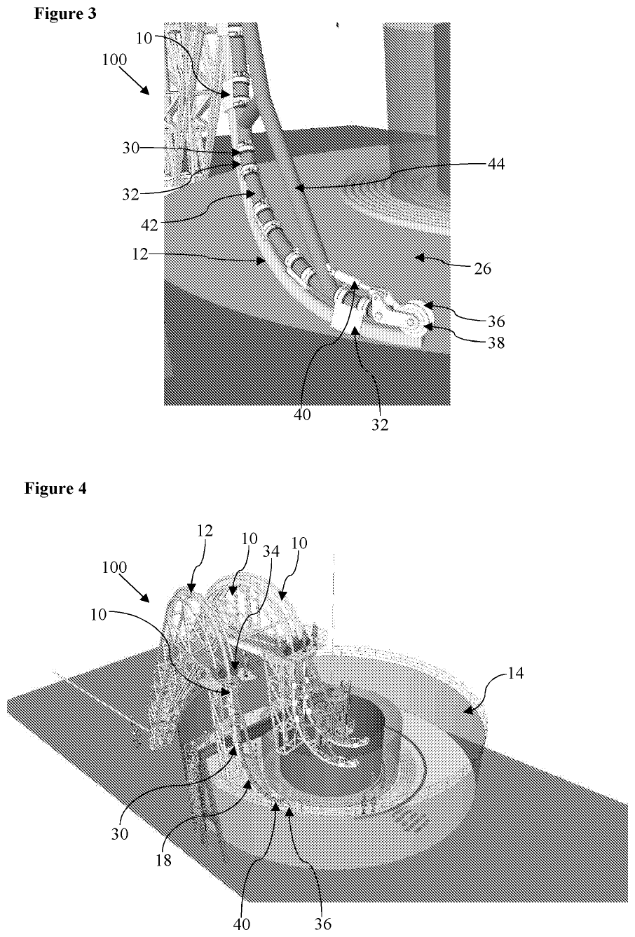

FIG. 3 shows an opposing side view of the spooling apparatus of FIG. 2;

FIG. 4 shows the spooling system of FIG. 1, with each exemplary spooling apparatus in a raised configuration with respect to the base of the container;

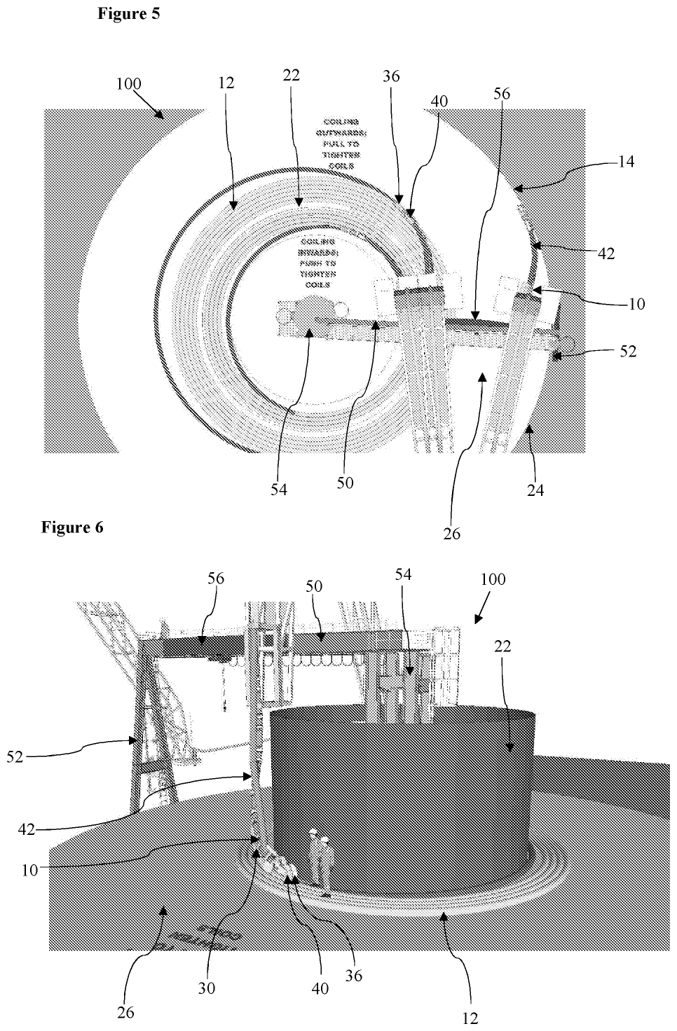

FIG. 5 shows a top view of the spooling system of FIG. 1, darker shaded flexible-elongate element sections illustrating the path of the flexible elongate element without the use of the spooling apparatus;

FIG. 6 shows a side view of the spooling system of FIG. 1 with one spooling apparatus spooling in an inwards direction, darker shaded flexible-elongate element sections illustrating the path of the flexible elongate element without the use of the spooling apparatus;

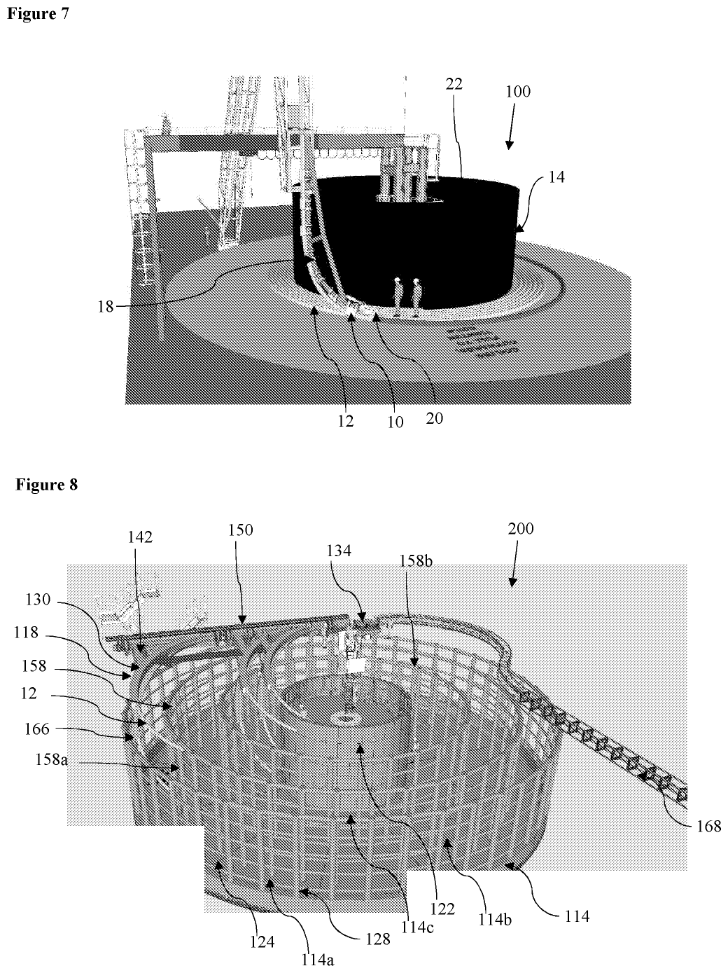

FIG. 7 shows a side view of the spooling system of FIG. 1 with one spooling apparatus spooling in an inwards direction, darker shaded flexible-elongate element sections illustrating the path of the flexible elongate element without the use of the spooling apparatus;

FIG. 8 shows a front view of a second embodiment of a spooling system in accordance with the first aspect of the invention, the spooling system having a spooling apparatus in accordance with the third aspect of the invention, six positions of the spooling apparatus being shown;

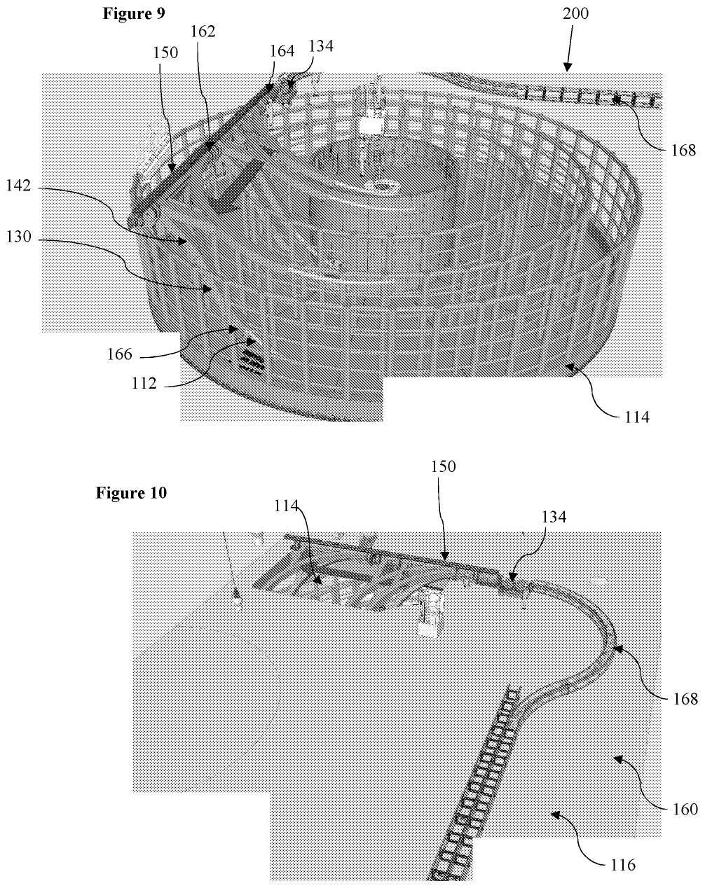

FIG. 9 shows a side view of the spooling system of FIG. 8; and

FIG. 10 shows a deck of a vessel, the spooling system of FIG. 8 being received below the deck.

Referring firstly to FIG. 1 there is shown a first embodiment of a vessel-supportable flexible-elongate-element spooling system 100 for spooling a flexible elongate element 12. The spooling system comprises a spooling apparatus 10 and a container 14 of a vessel 16. The spooling apparatus 10 comprises a flexible-elongate-element feeder 18 and a flexible-elongate-element force applicator 20.

The container 14 preferably comprises a cylindrical and/or radially inner barrier 22, here formed as a hub of the carousel, and a cylindrical and/or radially outer bather 24, here formed as an outermost wall of the carousel. Therefore, the container 14 has an annular cross-section. The inner barrier 22 and outer barrier 24 may each be walls, frames, baffles, guides, partitions or a series of posts such that each may prevent or limit the passage of a flexible elongate element 12. The container 14 has a base 26 or bottom and preferably the container 14 rotates such that the base 26 and/or each barrier 22, 24 moves around an axis of rotation. Therefore, the container 14 may be considered to be a carousel.

The base 26, inner and outer barriers 22, 24 together define an internal volume of the container 14. The container 14 may be on top of the deck of the vessel 16, may be underneath the deck and/or may extend through the deck. In any case, the container 14 has an opening 28 or inlet to allow the flexible elongate element 12 to enter and exit an interior of the container 14. Whilst the container 14 is described as having cylindrical bathers, it will be appreciated that other shaped containers 14 may be considered such as square containers, elliptical barriers or any other facetted or curvate shape. Additionally, the inner barrier in particular may not be necessary and therefore may not be included; however, the outer barrier may also not be included. Here the container 14 has two containment chambers or volumes, an inner chamber 14a and an outer chamber 14b. The inner barrier 22 of the outer chamber 14b defines the outer barrier of the inner chamber 14a. There may be a spooling apparatus for each chamber, or the same spooling apparatus may be used for both chambers.

Referring in addition to FIGS. 2 and 3, the flexible-elongate-element feeder 18 is adapted for feeding the flexible elongate element 12 to or towards the bottom or the base 26 of the container 14. Here the feeder 18 preferably includes a guide 30 configured to guide the flexible elongate element 12 to the base 26 and more preferably to define a curvature of the flexible elongate element 12. The guide 30 defines a downwards curve, in an axial direction of the container 14, and an inward curve, in a radial direction of the container 14, that is towards the inner barrier 22. As such, the guide 30 defines a helical or substantially helical curve, and/or defines a non-planar arc in at least two axes. However, it will be appreciated that the guide may not necessarily define a helical curve and instead the guide may only define a downwards curve or an inward curve. Alternatively, the guide may first define a downward curve followed by an inward curve.

The guide 30 preferably defines the curve by comprising a plurality of spaced apart guide elements 32 which are orientated to define a helical curve therebetween. Each guide element 32 here has a C-shaped or substantially C-shaped cross section and therefore supports three sides of the flexible elongate element 12. At least two of the guide elements 32 preferably have an open side of the C-shape facing opposing directions so that the guide 30 provides support to the flexible elongate element 12 on all sides. Alternatively, the guide elements 32 may have a circular cross-section and therefore may be annular, such as a hoop or a ring, although a single continuous tube may also be considered. Alternatively, the guide elements may be in the form of rollers set at appropriate angles to control the overall shape of the flexible elongate element.

The guide elements 32 are preferably rigid so as to resist deformation and thereby allow for imparting a curvature on the flexible elongate element 12. The guide elements 32 are therefore formed preferably from rigid material, such as metal, for example steel, and may have a low friction engaging surface for engagement with the flexible elongate element.

The feeder 18 may additionally comprise driving means, a driving element, or at least one tensioner 34 to provide a bias to move the flexible elongate element 12 into the container 14. Such driving means or tensioner 34 may be on the vessel 16 or external to the vessel. The tensioner 34, or each tensioner in the instance that there are multiple tensioners, may comprise a wheel tensioner, and thereby comprise two adjacent wheels which grip the flexible elongate element 12 therebetween and push it towards the container 14. Alternatively, the tensioner may be track tensioner, and thereby comprise two adjacent moveable caterpillar tracks which grip the flexible elongate element therebetween and push it towards the base of the container.

The force applicator 20 preferably comprises a flexible-elongate-element engagement member 36 at or adjacent to a container-base-proximal end of the feeder 18 or an outlet of the guide. The engagement member 36 is arranged or configured to engage the flexible elongate element 12 and preferably the in use flexible elongate element 12 is interengaged between the engagement member 36 and the base 26 or bottom of the container 14.

The engagement member 36 is preferably rotatable for rotatably engaging with the flexible elongate element 12. As such, the engagement member 36 is a wheel or roller. However, the engagement member may be tracked such as a caterpillar track which rotates around a central plane. Furthermore, the engagement member may not be rotatable for example being a low-friction planar member, such as a sliding, lubricated, greased or otherwise low-friction pad.

The spooling apparatus 10 may include a sensor on or associated with the rotatable engagement member 36. The sensor is preferably able to measure the speed of rotation of the engagement member 36. The sensor may be connected to a controller which may in turn be operatively connected to a driving means which drives rotation of the container 14. Additionally, the spooling apparatus 10 may comprise a force sensor for determining a force applied to the flexible elongate element 12 to prevent or limit damage thereto. Such a force sensor may, for example, be on or associated with the engagement member 36, tensioner 34 or guide 30.

The engagement member 36 preferably has an engagement surface 38 which is curvate so as to correspond to a circular cross-section of the flexible elongate element 12. The engagement surface 38 may therefore have at least one concave portion, for example having a groove with a semi-circular cross-section. In the instance that a roller is used the roller may be a diablo roller. Alternatively, the engagement surface may comprise a concave portion at each lateral side of the engagement member. Therefore, the engagement member an inward facing concave portion and an outward facing concave portion. Such concave portions may each comprise a groove with a quadrant-like cross-section.

The force applicator 20 preferably has a clamping or pinning condition for clamping the flexible elongate element 12 to the base 26 or bottom of the container 14 or an upper layer of flexible elongate element 12 in the container 14. Therefore, the force of engagement of the engagement member 36 with the flexible elongate element 12 may be adjustable. To facilitate such adjustment, the force applicator 20 may comprise an actuator 40 to adjust the position of the engagement member 36. The actuator 40 is preferably hydraulic or pneumatic, such as a piston, and here the actuator 40 is at or adjacent to the engagement member 36, although it will be appreciated that it may in fact be spaced apart therefrom.

The guide 30 and the force applicator 20 are preferably moveably supported. Such support may be provided via a moveable support, for example via a first support atm 42. The first support atm 42 is preferably curvate and the guide elements 32 are mounted onto the first support atm 42. In this way the first support atm 42 may have the same, a similar or a corresponding curvature as that defined by the guide 30. However, the first support atm may not be curvate and may, for example, be straight. The force applicator 20 is mounted at or adjacent to a base-proximal end of the first support atm 42.

The first support atm 42 is preferably at least in part flexible, pliable, articulable and/or pivotable so that the shape of the first atm and/or its position can be adjusted, although it may be rigid. Such a change in shape of the first support arm 42 may consequentially change the shape or pitch of the guide 30 and/or feeder 18. The first support arm 42 may not be adequately self-supporting, and therefore a second support atm 44 may be required to manipulate, support, provide rigidity and/or direct the first support atm 42. The second support atm 44 preferably attaches to the first support arm 42 at a position at or adjacent to the base 26 proximal end of the first support arm 42. The second support atm 44 is preferably additionally attached to the first support atm 42 via a connector at or adjacent to the middle of the first support arm 42. Such a connector may provide additional support to the first support atm 42.

The apparatus 10 preferably further comprises a mounting element 46 to which the first and second support arm 42, 44 are mounted and/or attached.

The first and/or second support aims 42, 44 may be tubes and therefore may preferably be hollow. Such a shape allows for wiring, for example electrical or hydraulic connectors, to be provided directly or indirectly to the force applicator 20. Whilst the first and second support aims 42, 44 are described as being moveable, it will be appreciated that they may in fact have a fixed arrangement.

The feeder 18 may further comprise a flexible-elongate-element feeding support 48 for directing the flexible elongate element 12 towards, up and into the flexible elongate element 12. Preferably the flexible-elongate-element feeding support 48 directs the flexible elongate element 12 upwards and here the feeding support 48 is sloped and or angled upwards and passes over a top of the outer barrier 24 of the container 14. The feeding support 48 includes an arch or arcuate portion at or adjacent to the top of the feeding support 48 to direct the flexible elongate element 12 back down to the base 26 of the container 14. Preferably, the feeding support 48 is a frame and/or is framework, although it will be appreciated that it may have other forms such as a continuous shell.

The feeding support 48 preferably extends downwards towards the bottom or base 26 of the container 14. The mounting element 46 is preferably movably mounted at or adjacent to a lower-end portion of the feeding support 48. For example, the mounting element 46 may be mounted on vertically or axially orientated mils or sliders and there may be a driving means, such as a motor 48a and chain or hydraulics to move the mounting element 46 towards and away from the bottom of the container 14. In this way the guide 30 and/or force applicator 20 is movable so that each may move vertically or in an axial direction of the container 14. Such axial movement allows for the guide 30 to be directed towards a plurality of axial positions or heights of the container 14 so as to accommodate the increase in height which the flexible elongate element 12 is spooled at due to layers of flexible elongate element 12 already having been deposited. FIG. 4 shows the mounting element 46, guide 30 and/or engagement member 36 in a raised condition, compared to a lowered condition in FIG. 1. The mounting element may be axially movably mounted at other positions, for example on the wall of the container or on a separate support, and not on the feeding support.

The spooling system 100 preferably further comprises a radial support 50. Here the radial support 50 provides reinforcement or additional rigidity to the spooling system 100, and in particular provides reinforcement to the feeding support 48, guide 30, force applicator 20 and/or mounting element 46. Here the radial support 50 extends across a radial extent of the container 14, and is supported by an A-flame 52 external to the container 14 and a pillar 54 at the centre of the container 14. However, the radial support 50 may be supported in other ways, for example to the superstructure of the vessel 16 and/or to the deck and may not necessarily be radially aligned. Preferably, the radial support 50 comprises a bridge and has a walkway to allow personnel to move across.

The feeding support 48, guide 30, force applicator 20 and/or the mounting element 46 are preferably radially movably mounted. Such radial mounting is such that the guide 30 and/or force applicator 20 may be provided to multiple locations on the base 26 of the container 14. Here there is a radial rail 56 which is attached to the radial support 50. The mounting element 46 is movable mounted to the radial mil 56. The radial mil 56 preferably extends at least in part across a radial extent of the container 14. In this way the guide 30, force applicator 20 and/or mounting element 46 may be moved radially across the container 14. Alternatively, the guide, force applicator and/or the moveable support may be mounted to a further support aim which is pivotable so as to radially adjust the position of the guide force applicator and/or the mounting element relative to the container.

In use, the vessel 16 which has the spooling system 100 may be positioned adjacent to a source of flexible elongate element 12. For example, the vessel 16 may be positioned adjacent to a dock with the flexible elongate element 12 thereon.

The flexible elongate element 12 is here a cable, such as a power transmission cable. The flexible elongate element 12 is preferably elastically flexible, such that it may be strained into a tighter curvature and on relaxation of the straining force it will revert to a less curved condition. As such the flexible elongate element 12 should have a degree of rigidity. Whilst the elongate element is described as being elastically flexible, it will be appreciated that it may in fact be plastically flexible. For example, in the instance that a steel catenary riser is used, the riser may be plastically deformed into a curvature so as to be stored in the container. On dispensation from the container, the riser may be deformed again so as to straighten it. Additionally, for flexible elongate elements which have components or layers with differing yield strengths, some components may be elastically deformed whilst others are plastically deformed. For example, in the instance of a lead coating of a copper or aluminium cored flexible elongate element, the lead may be plastically deformed whilst the copper or aluminium is elastically deformed.

The flexible elongate element 12 or an end thereof may be manoeuvred onto a deck of the vessel 16 and then onto the flexible-elongate-element feeding support 48. The flexible elongate element 12 may then be guided up the feeding support 48 and down into the container 14 and to the guide 30 of the feeder 18. A tensioner 34 of the feeder 18 may provide a bias to continuously feed the flexible elongate element 12 into the container 14 via the feeding support 48.

The guide 30 is first positioned so that the bottom end thereof is at a radial outward edge of the container 14 and at or adjacent to the outer wall. To prevent the mounting element 46 from clashing with the outer bather 24 of the container 14, the second support aim 44 pivots the container-base proximal end of the guide 30 and/or the second support arm 44 radially outward of their mounting point and/or the mounting element 46.

The flexible elongate element 12 is guided around or via the guide 30. The guide 30 imparts a curvature to the flexible elongate element 12 which requires straining or elastically deforming the flexible elongate element 12. In this way the flexible elongate element 12 is over curved or curved more than the flexible elongate element 12 would be curved at rest or without a force on the flexible elongate element 12. The guide 30 thereby restricts the flexible elongate element 12 and prevents or limits the flexible elongate element 12 from straightening or adopting a broad catenary curve. The flexible elongate element 12 therefore applies a reactionary force inwardly on the guide 30. A guide element 32 which restricts the outward movement of the flexible elongate element 12 is therefore not necessarily required in a central portion of the guide 30.

The flexible elongate element 12 is fed or directed onto the bottom of the container 14 and at, adjacent to or against the outer barrier 24. Such feeding is via the engagement member 36 which is here the roller. In this instance the roller 36 rotates with the flexible elongate element 12 to reduce frictional engagement therebetween and thereby allow the flexible elongate element 12 to pass. The container 14 rotates away from the guide 30. This is so that the tangential direction of movement at the guide 30 is in the same or substantially the same direction as a flexible elongate element 12 pathway along the guide 30. For example, the guide 30 extends at least in part in anti-clockwise direction around the container and the container 14 rotates in an anti-clockwise direction about its axis of rotation.

Thus, the end of the flexible elongate element 12 is drawn away from the guide 30 by the rotating container 14. This allows more flexible elongate element 12 into the container 14 and in the position the end of the flexible elongate element 12 previously occupied. The flexible elongate element 12 is fed around the outer barrier 24 so that it is at or adjacent to the outer barrier 24. The outer barrier 24 therefore at least in part defines the curvature imparted to the flexible elongate element 12. To ensure that the flexible elongate element 12 maintains a desired curvature and/or the curvature is matched to that of the outer barrier 24, the force applicator 20 applies a clamping, pinning or downward force on the flexible elongate element 12 so as to clamp or pin the flexible elongate element 12 to the base 26 of the container 14. This retains, holds or maintains the curvature imparted to the flexible elongate element 12 when discharged from the feeder 18 and at least in part defined by the outer barrier 24. To facilitate this, the actuator 40 may adjust the position of the engagement member 36 towards the base 26 of the container 14 and/or provide a downward force or urging force on the engagement member 36 towards the flexible elongate element 12 and towards the base 26. The clamping force applied by the engagement member 36 results in the flexible elongate element 12 being unable to move to deviate from the curvature of the outer barrier 24 and/or to straighten. The concave engagement surface 38 and/or the groove of the engagement member 36 prevents or limits the flexible elongate element 12 from moving laterally and/or radially with respect to the engagement member 36.

The flexible elongate element 12 is thereby spooled or laid into the container 14 in this manner around and against the outer barrier 24 of the container 14. Once the container 14 has rotated a full revolution, or 360°, the position of the guide 30 and force applicator 20 is moved radially inward. This is achieved by moving the feeding support 48 and/or the mounting element 46 on the radial mil 56. This is such that the bottom or an outlet of the guide 30 and/or the engagement member 36 is inward and at or adjacent of the already laid or first coil of flexible elongate element 12. Further flexible elongate element 12 is laid, with the container 14 rotating, in the same manner as previously described. The guide 30 and force applicator 20 move inwardly to lay further concentric coils, layers, spirals or rings of flexible elongate element 12 in the same way as previously described. The force applicator 20 continuously applies the pinning or clamping force on the flexible elongate element 12 during spooling to prevent or limit the flexible elongate element 12 from straightening, for example to prevent or limit the flexible elongate element 12 from extending across, rather than around, the base 26 of container 14. This is particularly required when the force applicator 20 is proximal to the inner barrier 22 because the desired radius of curvature of the flexible elongate element 12 becomes smaller and therefore the flexible elongate element 12 is strained more. The downward or clamping force is preferably held continuously during the laying of a layer or plane of flexible elongate element 12.

The effect of applying the clamping force is illustrated in FIGS. 5 and 6 in particular. In FIG. 5, for example, the inner darker shaded flexible elongate element 12 section indicates the curvature the flexible elongate element 12 would conventionally adopt without the use of the force applicator 20. This shows the gapping which would occur between adjacent coils. The innermost lighter shaded flexible elongate element 12 coil indicates the curvature of the flexible elongate element 12 which is retained with the use of the force applicator 20. Similarly, in FIG. 5 the darker shaded flexible elongate element 12 section shows the conventional natural or equilibrium curvature of the flexible elongate element 12. The innermost lighter shaded flexible elongate element 12 coil indicates the curvature of the flexible elongate element 12 which is retained with the use of the force applicator 20.

When the guide 30 and the force applicator 20 are moved such that the flexible elongate element 12 is at or adjacent to the inner barrier 22 and preferably has laid a coil of flexible elongate element 12 at or adjacent to the inner barrier 22, the first plane of flexible elongate element 12 is complete. The guide 30 may be pivoted inwardly of the mounting element 46 to prevent or limit the risk of the mounting element 46 from clashing with the inner barrier 22. The force applicator 20 and guide 30 are then moved upwards and/or in an axial direction of the container 14. This is achieved by moving the mounting element 46 on the feeding support 48. To lay a second layer of flexible elongate element 12, the flexible elongate element 12 is laid in a groove defined between the top of the innermost coil of flexible elongate element 12 and the inner barrier 22 or an adjacent outer coil. The flexible elongate element 12 is then spooled outwards, towards the outer barrier 24 in the similar or the same way as the flexible elongate element 12 was spooled inwards. The second layer of the flexible elongate element 12 is preferably laid in the grooves defined by adjacent coils of the first layer of flexible elongate element 12. Since the flexible elongate element 12 in the second layer spirals in the opposite direction to the spiralling direction of the first layer, there is a position around the circles at which the flexible elongate elements 12 in the first layer “crosses over” to the next adjacent groove. The force applicator 20 maintains a force on the flexible elongate element 12 as it is laid so as to clamp the flexible elongate element 12 onto the first layer flexible elongate element 12. This retains, holds or maintains the curvature imparted to the flexible elongate element 12 when discharged from the feeder 18 and at least in part defined by the inner barrier 22.

The effect of applying the clamping force is illustrated in FIGS. 5 and 7 in particular. In FIG. 5, for example, the outer darker shaded flexible elongate element 12 section indicates the curvature the flexible elongate element 12 would conventionally adopt without the use of the force applicator 20. This shows the gapping which would occur between adjacent coils. The outermost lighter shaded flexible elongate element 12 coil indicates the curvature of the flexible elongate element 12 which is maintained with the use of the force applicator 20. Similarly, in FIG. 7 the darker shaded flexible elongate element 12 section shows the conventional, natural or equilibrium curvature of the flexible elongate element 12. The outermost lighter shaded flexible elongate element 12 coil indicates the curvature of the flexible elongate element 12 which is maintained with the use of the force applicator 20.

The spooling system 100 continues to spool flexible elongate element 12 in this manner, spooling alternately in an inward manner and then an outward manner, inward and outward spooling layers being separated vertically or axially. However, it will be appreciated that the spooling system 100 may spool the first layer in an inward-to-outward direction, or may initially lay in the middle of the container 14.

The rotatable engagement member 36 would rotate with the flexible elongate element 12, and the sensor can record the rate of rotation of the engagement member 36. The rate of rotation of the engagement member 36 is dependent on or corresponds to the speed of movement of the flexible elongate element 12, which in tum is dependent on or corresponds to the rate of rotation of the container 14 and the distance from the centre of the container. In this way, the sensor of the rotatable engagement member 36 can determine the real-time tangential speed of motion of the container base 26 adjacent to the end of the guide 30. A rate of feeding of the flexible elongate element 12 can be adjusted based on this speed, or the rate of rotation of the container 14 adjusted. The controller, which is linked to the sensor, may be able to automatically adjust the driving means which drives the rotation of the container 14, so that the container 14 is rotated at a required rate.

In the instance that the engagement member 36 has a concave portion at each lateral side, it will be appreciated that the outward facing concave portion may engage the elongate flexible element when spooling from the outer barrier 24 to the inner barrier 22. This may assist with clamping the flexible elongate element 12 against the outer barrier 24 or against outward coils. The inward facing concave portion may engage the flexible elongate element 12 when spooling from the inner barrier 22 to the outer to assist with clamping the flexible elongate element 12 against the inner barrier 22 or against inward coils.

When the container 14 is loaded and the vessel 16 manoeuvred to an overboarding site, the flexible elongate element 12 may be drawn or uncoiled from the container 14 and overboarded in a conventional manner. However, the spooling system may not be limited to overboarding vessels and may be used in any flexible elongate element transport vessel. The spooling system could also in fact be used in any maritime or non-maritime scenario and so may not necessarily be vessel supportable. For example, the spooling system may be used to store flexible elongate element at or proximal to the facility or factory where the flexible elongate element is produced, or alternatively on the dock-side. Land-based containers typically have a larger diameter than that of a vessel supportable container.

Additionally or alternatively, in the instance that the engagement member 36 is rotatable, the engagement member 36 may be drivable and therefore may have a driving means. The driving means may, for example, be a motor remotely controllable or operable. The direction of rotation of the engagement member 36 is preferably reversible and therefore the motor is a reversible motor.

In use, with a drivable engagement member 36, the flexible elongate element 12 may be directed to the engagement member 36 in the same way as previously described and the guide 30 may be positioned at or adjacent to the outer barrier 24 in the same way as previously described.

When spooling the flexible elongate element 12 from the outer barrier 24 to the inner barrier 22, the engagement member 36, for example the roller, is rotated so as to drive the flexible elongate element 12 away from the guide 30 and towards the outer barrier 24. In this way, the flexible elongate element 12 is forced into and/or against the outer bather 24. By forcing the flexible elongate element 12 in this way, the desired curvature of the flexible elongate element 12 is maintained. The pushing force strains the flexible elongate element 12 and therefore prevents or limits the flexible elongate element 12 from adopting a less curved state. The force applicator 20 therefore pushes the flexible elongate element 12 and is in a pushing condition whilst laying the flexible elongate element 12. The flexible elongate element 12, and in particular the inner surface thereof, may for example be in a slight state of compression. The force applicator 20 may utilise the clamping condition, in addition to the pushing condition to additionally maintain the curvature of the flexible elongate element 12. However, it will be appreciated that this is not necessary.

The spooling system 100, with the container 14 rotating, spools inwardly with concentric coils towards the inner barrier 22 in the same way as previously described. The force applicator 20 pushes the flexible elongate element 12 being laid into an adjacent and outward coil to maintain the desired curvature.

When spooling the flexible elongate element 12 from the inner wall to the outer wall, the rotation of the rotatable engagement member 36 is reversed so as to pull the flexible elongate element 12 towards the guide 30. In this way the force applicator 20 applies a pulling force or tension on the flexible elongate element 12 and is in a pulling condition. The container 14 is rotated so as to draw flexible elongate element 12 into the container 14; however, a tension remains axially along the flexible elongate element 12 to pull the flexible elongate element 12 around the inner bather 22. This prevents or limits the flexible elongate element 12 from adopting a less curved condition and therefore prevents or limits the flexible elongate element 12 from extending across the base 26 of the container 14, rather than around the inner bather 22. Similarly, to previously, the force applicator 20 may maintain the clamping or pinning condition.

Alternatively, the force applicator 20 may not comprise the engagement member 36. Instead, the force applicator 20 may comprise the tensioner 34, which may be remote from the container 14, or may be on the feeding support 48. The feeder 18 or guide 30 restricts the curvature of the flexible elongate element 12 and therefore prevents the flexible elongate element 12 from adopting a catenary curve. Due to the rigidity of the flexible elongate element 12, the length of the natural catenary curve would typically be too great for the container 14 to accommodate. Additionally or alternatively, the feeder 18 or guide 30 provides a gradual transition of the flexible elongate element 12 from the vertical condition to horizontal condition. Without the gradual transition, the flexible elongate element 12 could develop kinks or bending which is less than the minimum bend radius when the flexible elongate element 12 engages with the base 26. This is particularly the case if the flexible elongate element 12 is being driven axially.

In this instance, when spooling from the outer barrier 24 to the inner barrier 22, the tensioner 34 applies an active axial force along the length of the flexible elongate element 12. Such an axial force may result in a compressive force on the flexible elongate element 12. The force applicator 20 is in the pushing condition. The guide 30 directs the flexible elongate element 12 towards the outer barrier 24 and pushes the flexible elongate element 12 against the wall. Therefore, the desired curvature of the flexible elongate element 12 is maintained. To apply the pushing force, the rate of feeding of the flexible elongate element 12 into the container 14 may be greater than, and preferably only slightly greater than, the tangential speed of movement of the container 14 at or adjacent to the end of the guide 30. Thus, the spooling system 100 may comprise a sensor to measure the tangential speed of movement of the container 14 and a controller may use this speed to set the speed of feeding of the flexible elongate element 12, which may be adjusted via the tensioner 34.

When spooling from the inner barrier 22 to the outer barrier 24, the force applicator 20 is preferably in the pulling condition and the force applicator 20 provides an axial tensile force along the flexible elongate element 12. To apply a pulling force the rate of feeding of the flexible elongate element 12 into the container 14 may be less than, and preferably only slightly less than, the tangential speed of movement of the container 14 at or adjacent to the end of the guide 30.

Whilst the container is described as being rotatable, it will be appreciated that the container may be fixed and the spooling apparatus may be rotatable around the container.

Referring to FIGS. 8 to 10, there is shown a second embodiment of the spooling system 200. Similar or identical reference numerals as the first embodiment are used, with 100 added.

The container 114 of the spooling system 200 includes a plurality of partitions 158 between the outermost barrier 124 and the innermost barrier 122, or hub. Here there are two partitions 158, although it will be appreciated that only one partition or more than two partitions may be considered. Additionally, the partitions may be omitted if not required.

Separate or distinct chambers 114 or volumes are defined between the outer barrier 124, partitions 158 and hub 122, and the flexible elongate element 12 may be fed into each of these chambers 114. A first chamber 114a may be considered to be defined between the outermost barrier 124 and an outer partition 158a. For the flexible elongate element in the first chamber 114a, the outermost barrier 124 acts as a radially outer barrier, and the outer partition 158a acts as a radially inner bather. Similarly, a second chamber 114b is defined between the outer partition 158a and the inner partition 158b. For the flexible elongate element in the second chamber 114b the outer partition 158a acts as the radially outer bather and the inner partition acts as the radially inner bather. Additionally, a third chamber 114c is defined between the inner partition and the innermost wall, or the hub 122. For the flexible elongate element in the third chamber 114c the inner partition 158b acts as the radially outer barrier and the innermost wall 122 acts as the radially inner bather. The inside of the hub 122 is preferably not used for receiving flexible elongate element.

The outermost bather 124 and the partitions 158 are constructed as frameworks, a framework here being a trellis type wall or structure. It will be appreciated that this may not be the case and each, and in particular the outermost bather, may comprise continuous walls. The hub 122 comprises a continuous wall, although it will be appreciated that this may instead be framework.

The container 114 is preferably received below deck of a vessel 116, although it will be appreciated that it may be received above deck 160 or part above and part below deck 160.

The system 200 comprises a feeder 118 and a force applicator 120. The flexible-elongate-element feeder 118 here comprises a tube 130 which acts as a guide for the flexible elongate element 12. The tube 130 has a square cross-section, although it will be appreciated that conduits having other cross-sections may be considered, such as circular, hexagonal or other polygonal or curvate shapes. Preferably, at least a majority of the perimeter of the cross-section of the tube 130 has continuous walls, and the entire tube 130 may have a continuous and/or contiguous wall. However, it will be appreciated that at least one wall of the tube may comprise apertures therein, for example a grill which may be removable, which may assist with removal of bitumen of other substances which may cause blockages within the tube 130. In this instance the tube could be considered to be formed as a rigid mesh, in full or in part. Additionally, at least part of the axial extent of the tube 130 may be openable, which may additionally assist with removing blockages. Whilst a tube is described it will be appreciated that spaced apart but interconnected guide elements may also be considered, as per the previous embodiment.

The tube 130 is curvate or curved and is only curved in one plane. Here the tube 130 is curved in a horizontal plane, and is not curved in a vertical plane. As such the tube 130 does not define a helical curve. However, it will be appreciated that the tube 130 may have a helical curve, as per the previous embodiment and shown in FIG. 1, for example. The curvature of the tube 130 preferably matches that of at least one of the outermost barrier 124, partitions 158, or hub 122, although it will be appreciated that this may not be the case.

The tube 130 may include rollers or wheels therein to assist with movement of the flexible elongate element 12 therethrough.

The tube 130 is mounted to a radial support 150. As shown in FIG. 10, the radial support 150 is mounted to an upper surface of the deck 160 of the vessel 116 and the deck 160 has a hole 162 therein to accommodate the tube 130 through the deck 160. However, it will be appreciated that the radial support 150 may be mounted below deck 160, for example to an underside of the deck 160.

The tube 130 is moveably and preferably slidably mounted to the radial support 150 so that the tube 130 is translatable along at least part of a radial extent of the radial support 150. To achieve this, the tube 130 is mounted to a mounting member 162, such as a carriage, which is moveable along the radial support 150. The radial support 150 in this respect may comprise a mil. A plurality of further independently moveable carriages 164 are between the mounting member 162 and the innermost end of the rail 150. The carriages and mounting member 164, 162 are interconnected by strops or other connecting elements which assists with restricting unwanted movement of the tube 130, for example unwanted movement lateral to a direction of the radial support 150. The carriage may be driven along the radial support 150 via the use of hydraulics or a motor. The mounting member 162 and/or carriages are circular or disc shaped which may assist with permitting pivoting thereof.

The tube 130 is preferably pivotally mounted relative to the radial support 150 and/or to the mounting member 162. In this way, the tube 130 is pivotable in a vertical direction or axis so that an end 166 of the tube 130 can be moved towards the bottom or base of the container. As shown in FIG. 9, an end 166 of the tube 130 is spaced apart from the bottom 126 of the container, for example being spaced apart by approximately 2 metres. However, it will be appreciated that this may not be the case and the tube 130 may extend to the base 126.

A support aim 142 is moveably or slidably, as well as pivotably, mounted relative to the radial support 150 and is moveable with the tube 130. The support aim provides structural support to the tube 130.

Here the force applicator 120 comprises a tensioner 134, which is preferably a wheeled tension, although it is appreciated that tracked tensioners may also be considered. The tensioner 134 is here at or adjacent to an upper end of the tube 130; however, it will be appreciated that the tensioner may be further upstream of the tube 130. The spooling system comprises an upstream guide 168 for guiding the flexible elongate element 12 upstream of the tube 130 and here is on the surface of the deck 160 of the vessel 116.

The interior of the hub 122 comprises a staircase, for example a spiral staircase, for permitting workers to access different vertical heights of the container. The hub 122 may comprise apertures in a wall thereof for permitting workers to access the cable receiving volume of the container 114.

In use, the flexible elongate element 12 is directed along the upstream guide 168, through the tensioner and through the tube 130. The tube 130 is pivoted so that the end 166 of the tube 130 is at or adjacent to the bottom of the container and the tube 130 is translated so that the end 166 of the tube 130 is at or adjacent to the outermost bather. The container 114 is rotated so that the base of the container 114 moves away from the end 166 of the tube 130, for example in an anti-clockwise direction from the perspective of FIG. 8.

The tensioner 134 applies an active axial force along the length of the flexible elongate element 12. Such an axial force may result in a compressive force on the flexible elongate element 12. The force applicator 120 is in the pushing condition. The tube 130 directs the flexible elongate element 12 towards the outer barrier 124 and pushes the flexible elongate element 12 against the wall. Therefore, the desired curvature of the flexible elongate element 12 is maintained. To apply the pushing force, the rate of feeding of the flexible elongate element 12 into the container 114 may be greater than, and preferably only slightly greater than, the tangential speed of movement of the container 114 at or adjacent to the end 166 of the tube 130. Thus, the spooling system 100 may comprise a sensor to measure the tangential speed of movement of the container 114 and a controller may use this speed to set the speed of feeding of the flexible elongate element 12, which may be adjusted via the tensioner 134.

When the container 114 has performed a revolution so that a loop or coil of flexible elongate element 12 is lain, the tube 130 is translated radially inwards so that the flexible elongate element 12 is fed to the base 126 of the container 114 at or adjacent inward of the first loop. The flexible elongate element 12 is pushed against the first loop via the tensioner 134 so that the curvature of the flexible elongate element 12 is maintained and or matched to that of the outermost barrier 124. This is repeated until the end 166 of the tube 130 reaches the outer partition and so a first layer of flexible elongate element 12 is lain in the first chamber 114a.

The tube 130 may then be pivoted upwards so that the flexible elongate element 12 is lain on top of the previous loop of flexible elongate element 12, or in a groove between the previous two loops of flexible elongate element 12. When spooling from the outer partition 158a to the outermost barrier 124, the force applicator 120 is preferably in the pulling condition and the force applicator 120 provides an axial tensile force along the flexible elongate element 12. To apply a pulling force the rate of feeding of the flexible elongate element 12, provided via the tensioner 134, into the container 114 may be less than, and preferably only slightly less than, the tangential speed of movement of the container 114 at or adjacent to the end of the guide 30.

The tube 130 is translated outwardly so that a second layer of flexible elongate element 12 is lain above the first layer. This process is repeated until multiple layer of flexible elongate element 12 fill, or at least in part fill, the first chamber 114a. The tube 130 is pivoted upwards so that and then translated inwardly so that the end 166 of the tube 130 moves above the outer partition 158a and to the second chamber 114b. The second chamber 114b is filled in a similar or identical way to the first chamber 114a. The tube 130 is then moved to the third chamber 114c and the third chamber 114c is filled.

Whilst described as being used on a vessel, it will be appreciated that the second embodiment of the spooling system 200 may be used on land, such as on the dock-side, as described for the previously described embodiment.

Whilst the container is shown as having a vertically oriented axis of rotation, it will be appreciated that it may in fact have a horizontal axis of rotation. In this way the carousel may be considered to be a reel, rather than a carousel.

It is therefore possible to provide a spooling apparatus and system which applies a force on a flexible elongate element as it is being laid into a container. The force may either be a pushing, pulling or pinning force. The force prevents or limits the flexible elongate element from deviating from a desired curvature and so helps maintain a tighter curvature. This reduces gapping in the coils of spooled flexible elongate element.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A vessel-supportable flexible-elongate-element spooling system to spool a flexible elongate element, the system comprising:
a container having an internal volume defined by a radially inner barrier, a radially outer barrier, and a base;
a flexible-elongate-element feeder to feed the flexible elongate element towards the base of the container; and
a flexible-elongate-element force applicator to apply a force to the flexible elongate element to retain a curvature imparted to the flexible elongate element on discharge from the flexible-elongate-element feeder, the curvature at least in part defined by at least any one of the inner barrier and the outer barrier.

2. The vessel-supportable flexible-elongate-element spooling system as claimed in claim 1, further comprising a radial support which extends across at least part of a radial extent of the container, the radial support configured to support at least any one of the feeder and the force applicator.

3. The vessel-supportable flexible-elongate-element spooling system as claimed in claim 2, wherein the feeder is configured to be moved along the radial support.

4. The vessel-supportable flexible-elongate-element spooling system as claimed in claim 1, wherein the feeder includes a guide configured to impart a helical curve to the flexible elongate element.

5. (canceled)

6. The vessel-supportable flexible-elongate-element spooling system as claimed in claim 4, wherein the guide is configured to be pivoted.

7. The vessel-supportable flexible-elongate-element spooling system as claimed in claim 4, wherein the guide comprises a tube.

8. (canceled)

9. The vessel-supportable flexible-elongate-element spooling system as claimed in claim 4, wherein the guide has a plurality of flexible-elongate-element guide elements which are spaced apart and oriented to define a helical curve therebetween.

10. The vessel-supportable flexible-elongate-element spooling system as claimed in claim 1, wherein the force applicator has a pushing condition to push the flexible elongate element outwards when spooling the flexible elongate element from the outer barrier to the inner barrier.

11. The vessel-supportable flexible-elongate-element spooling system as claimed in claim 1, wherein the force applicator has a pulling condition to pull the flexible elongate element inwards when spooling the flexible elongate element from the inner barrier to the outer barrier.

12. The vessel-supportable flexible-elongate-element spooling system as claimed in claim 1, wherein the force applicator has a pushing condition to push the flexible elongate element outwards when spooling the flexible elongate element from the outer barrier to the inner barrier, and wherein the force applicator has a pulling condition to pull the flexible elongate element inwards when spooling the flexible elongate element from the inner barrier to the outer bather, further comprising a switching means to switch the force applicator between the pushing condition and the pulling condition.

13. (canceled)

14. The vessel-supportable flexible-elongate-element spooling system as claimed in claim 1 wherein the force applicator is a tensioner.

15. (canceled)

16. The vessel-supportable flexible-elongate-element spooling system as claimed in claim 1, wherein the force applicator comprises a flexible-elongate-element engagement member at or adjacent to a container-base-proximal end of the feeder.

17. The vessel-supportable flexible-elongate-element spooling system as claimed in claim 16, wherein the flexible-elongate-element engagement member is configured to rotate to rotatably engage with the flexible elongate element.

18. (canceled)

19. (canceled)

20. The vessel-supportable flexible-elongate-element spooling system as claimed in claim 17, wherein the engagement member includes a sensor to measure a rate of rotation of the flexible-elongate-element engagement member.

21. (canceled)

22. (canceled)

23. The vessel-supportable flexible-elongate-element spooling system as claimed in claim 16, wherein the flexible-elongate-element engagement member is driven so as to act in at least one of the following ways: to push the flexible elongate element, and to pull the flexible elongate element

24. The vessel-supportable flexible-elongate-element spooling system as claimed in claim 1, wherein the force applicator has a clamping condition to clamp the flexible elongate element in at least one of the following ways: to a base of the container, and to a flexible elongate element upper layer.

25. The vessel-supportable flexible-elongate-element spooling system as claimed in claim 1, wherein the force applicator comprises a flexible-elongate-element engagement member at or adjacent to a container-base-proximal end of the feeder, wherein the force applicator has a clamping condition to clamp the flexible elongate element in at least one of the following ways: to a base of the container, and to a flexible elongate element upper layer, and wherein the force applicator further comprises an actuator configured to adjust a pressure applied by the engagement member on the flexible elongate element.

26. The vessel-supportable flexible-elongate-element spooling system as claimed in claim 1, wherein at least part of the container is configured to rotate.

27. (canceled)

28. (canceled)

29. A method of spooling a flexible elongate element into a container of a vessel, the container having a cylindrical inner barrier and a cylindrical outer barrier, the method comprising the steps:
a) feeding the flexible elongate element towards a base of the container; and
b) applying a force to the flexible elongate element to hold a curvature of the flexible elongate element.

30. The method as claimed in claim 29, wherein at least part of the container is configured to rotate and force is applied to the flexible elongate element when spooling from the inner barrier to the outer barrier by adjusting a rate of rotation of said at least part of the container and a rate of feeding of the flexible elongate element so that the rate of rotation is different to a rate of feeding.

31. (canceled)

32. (canceled)
